(19) United States
(12) Patent Application Publication
(10) Pub. No.: US 2004/0018390 A1
(43) Pub. Date: Jan. 29, 2004

(54) Perpendicular magnetic recording medium and method of manufacturing the same

(75) Inventor: Manabu Shimosato, Nagano (JP)

Correspondence Address: Mare A. Rossi, ROSSI & ASSOCIATES, P.O. Box 826, Ashburn, VA, 20146-0826, US

(73) Assignee: Fuji Electric, Co., Ltd.

(21) Appl. No.: 10/371,967

(22) Filed: Feb. 21, 2003

Related U.S. Application Data
(63) Continuation-in-part of application No. 10/209,675, filed on Jul. 31, 2002.

(30) Foreign Application Priority Data
Jul. 8, 2002 (JP) JP2002-199249
Jul. 31, 2001 (JP) JP 2001-232786

(51) Int. Cl. G11B 5/72

(52) U.S. Cl. 428/694 TS; 428/694 BP; 428/695

(57) ABSTRACT

A perpendicular magnetic recording medium and method with reduced media noise has an under-layer, an intermediate layer with an amorphous structure, a recording layer, a protective layer, and a liquid lubricant layer sequentially laminated on a substrate. By providing the amorphous intermediate layer, the recording layer, which is formed on the intermediate layer, is made to have a fine grain size and a uniform grain size distribution. A perpendicular magnetic recording medium and method of the invention can be alternatively provided with an intermediate layer consisting of an amorphous layer and a crystalline layer.

### CROSS-REFERENCE TO RELATED APPLICATIONS

This application is a continuation-in-part application of and claims priority from U.S. patent application Ser. No. 10/209,675 filed on Jul. 31, 2002, the contents of which are incorporated herein by reference.

### BACKGROUND

A rapid increase in information quantity in communications is pushing for magnetic recording media with a higher recording density. Enhancement of recording density as high as 100% per year has been demanded in recent years. Conventional planar magnetic recording will limit the enhancement of recording density in the near future. To overcome this limit, a perpendicular magnetic recording medium has been proposed where magnetization is formed in the direction perpendicular to the substrate plane.

The higher the recording density, however, the higher the media noise, which increases in proportion to the linear recording density. Media noise is large in a conventional perpendicular magnetic recording medium, causing a serious problem. Methods of reducing media noise in a perpendicular magnetic recording medium have been proposed, including the use of amorphous carbon in an intermediate layer as disclosed in Japanese Unexamined Patent Application Publication No. H6-176340, and the use of metals or alloys of Zr, Ru, Ti, or CoCr alloy in an intermediate layer or in an under-layer as disclosed in Japanese Unexamined Patent Application Publication Nos. H10-11735 and 2001-93139. All these methods reduce media noise by improving alignment of crystal structure of a magnetic layer formed on the intermediate layer. There still remains a need for alternative methods of reducing media noise. That is, the known methods are not sufficient for further reduction of media noise. The present invention addresses this need.

In view of the above, it would be desirable to reduce media noise to the lowest level that is compatible with the higher recording density in a perpendicular magnetic recording medium. Further, it would be desirable to improve the coercive force Hc and the squareness ratio S.

### SUMMARY OF THE INVENTION

The present invention relates to a magnetic recording medium, such as used in a hard disk or other equipment, in particular, to a perpendicular magnetic recording medium and a method of manufacturing such a magnetic recording medium.

A first aspect of a first mode of the present invention is a perpendicular magnetic recording medium having a substrate and an under-layer, an intermediate layer having an amorphous structure, a recording layer, a protective layer, and a liquid lubricant layer sequentially laminated on the substrate. The recording layer formed on the intermediate layer has a fine grain size and a uniform grain size distribution by providing the intermediate layer with the amorphous structure.

A second aspect of the first mode of the present invention is a method of manufacturing the perpendicular magnetic recording medium comprising the steps of sequentially laminating the under-layer, the intermediate layer, the recording layer, the protective layer, and the liquid lubricant layer on the substrate. Because the intermediate layer has an amorphous structure, the recording layer formed on the intermediate layer has a fine grain size and a uniform grain size distribution.

The composition of the intermediate layer can be of Ti₁₀₀₋ₐXₐ, where X can be chromium (Cr) or ruthenium (Ru) and a can be 0≦a<100 in atomic percent, or can be of Zr_{100-b}Y_{b}, where Y can be Cr or Ru and b can be 0≦b<100 in atomic percent. More specifically, a can be 0<a≦50, and X can be Cr, and b can be 0<b≦75, and Y can be Ru.

The thickness of the intermediate layer can be in the range from 1 nm to 20 nm.

The present invention in a second mode provides a perpendicular magnetic recording medium and a manufacturing method thereof, wherein the medium has an intermediate layer of a lamination of an amorphous layer and a crystalline layer deposited on the amorphous layer. Such an intermediate layer achieves improvements in the coercive force He and the squareness ratio S, as well as reduction in media noise.

Material for the amorphous layer of the intermediate layer is preferably a titanium alloy, more preferably an alloy of Ti and Cr, most preferably an alloy having a composition Ti_{100-c}Cr_{c}, wherein c is in the range from 10 to 25 at %. Material for the crystalline layer of the intermediate layer is preferably a CoCrPt alloy, more preferably a CoCrPtB alloy. One or more additives, including Ta, Nb, Cu, Ru, Ti, Pd, and Ni, may be contained in the crystalline layer. The crystalline layer has preferably a hexagonal closest packed structure.

### BRIEF DESCRIPTION OF THE DRAWINGS

The invention will be described in greater detail with reference to certain preferred embodiments thereof along with the accompanying drawings, wherein:

FIG. 1 is a schematic cross-sectional view of a perpendicular magnetic recording medium according to the first mode of the present invention;

FIG. 2 is a schematic cross-sectional view of a perpendicular magnetic recording medium according to the second mode of the present invention;

FIG. 3 is a transmission electron micrograph of a perpendicular magnetic recording medium of Example 1-1 according to the present invention;

FIG. 4 is a transmission electron micrograph of a perpendicular magnetic recording medium of Example 1-2 according to the present invention;

FIG. 5 is a transmission electron micrograph of a perpendicular magnetic recording medium of Example 1-3 according to the present invention;

FIG. 6 is a transmission electron micrograph of a perpendicular magnetic recording medium of Example 1-4 according to the present invention;

FIG. 7 is a transmission electron micrograph of a perpendicular magnetic recording medium of Comparative Example 1-1;

FIG. 8 is a transmission electron micrograph of a perpendicular magnetic recording medium of Comparative Example 1-2;

FIG. 9 is a transmission electron micrograph of a perpendicular magnetic recording medium of Comparative Example 1-3;

FIG. 10 is a transmission electron micrograph of a perpendicular magnetic recording medium of Example 2-1 according to the present invention; and

FIG. 11 is a transmission electron micrograph of a perpendicular magnetic recording medium of Comparative Example 2-1.

### DETAILED DESCRIPTION OF THE PREFERRED EMBODIMENTS

The present invention in the first mode will be described referring to FIG. 1. FIG. 1, however, is a mere exemplary embodiment. Accordingly, the present invention is not to be limited to this embodiment. A perpendicular magnetic recording medium of the present invention has a magnetic layer with a fine grain size and a small variance in the grain size by using an intermediate layer 13. The intermediate layer 13 in the medium has an amorphous structure that makes the grain size of the recording material formed on the intermediate layer 13 and the variance of the grain size small. The distribution of the grain size is made uniform by forming the intermediate layer 13 with the amorphous structure.

The perpendicular magnetic recording medium has an under-layer 12, an intermediate layer 13, a recording layer 14, a protective layer 15, and a liquid lubricant layer 16 sequentially laminated on a substrate 1. The intermediate layer 13 has an amorphous structure. The grain size of the recording layer material on the intermediate layer 13 is made fine and distribution of the grain size is made uniform by forming the intermediate layer 13 with an amorphous structure. The intermediate layer 13 can be an alloy, including titanium or zirconium. Specifically, the composition of the intermediate layer can be Ti₁₀₀₋ₐXₐ, where X is Cr or Ru and a is 0≦a<100 in atomic percent, or Zr_{100-b}Y_{b}, where Y is Cr or Ru and b is 0≦b<100 in atomic percent. More specifically, a and b can be 0<a≦50 and 0<b≦75, respectively. More specifically, X can be Cr and Y can be Ru. The thickness of the intermediate layer can be in the range from 1 nm to 20 nm.

The method of the present invention for manufacturing a perpendicular magnetic recording medium comprises the steps of sequentially laminating at least the under-layer 12, the intermediate layer 13, the recording layer 14, the protective layer 15, and the liquid lubricant layer 16 on the substrate 11.

Known methods of reducing media noise in a perpendicular magnetic recording medium include a method to reduce magnetization of crystal grains in the recording layer, a method to reduce magnetic interaction between crystal grains in the recording layer, and a method to improve alignment of crystal grains in the recording layer. Media noise in the perpendicular magnetic recording medium, however, is reduced according to the present invention by reducing the grain size and the variance of the grain size of the recording layer.

The material that can be used in the substrate 11 in the present invention includes a NiP-plated aluminum alloy, strengthened glass, and crystallized glass, which are all used in a conventional magnetic recording medium.

The material for the under-layer 12 can be selected from the materials suitable for a soft magnetic underlayer for perpendicular magnetic recording, and including an amorphous cobalt alloy, a NiFe alloy, a sendust alloy (i.e., an FeSiAl alloy), and an FeTaC alloy. In the present invention, in particular, the NiFe alloy is preferable. Examples of amorphous cobalt alloys include CoNbZr and CoTaZr. The thickness of the under-layer 12 can be in the range from 5 nm to 200 nm, the optimum value depending on the structure and characteristics of the magnetic head used for recording.

In the first mode of the present invention, Ti, Zr, or an alloy containing these metals can be used in the intermediate layer 13. Specifically, the composition of the intermediate layer 13 in the present invention can be Ti₁₀₀₋ₐXₐ, where X is Cr or Ru and a is 0≦a<100 in atomic percent, or Zr_{100-b}Y_{b}, where Y is Cr or Ru, and b is 0≦b<100 in atomic percent. More specifically, a and b can be 0<a≦50 and 0<b≦75, respectively. More specifically, X can be Cr and Y can be Ru, with the alloys of Ti75-Cr25 and Zr50-Ru50 being most preferable.

The material of the intermediate layer 13 in the first mode of the invention needs to be amorphous or has to have an amorphous structure. By making the intermediate layer 13 amorphous and forming the recording layer 14 according to the manufacturing method for a perpendicular magnetic recording medium as described later, the grain size of the recording layer is decreased and the variance of the grain size is minimized, leading to reduction in media noise.

The thickness of the intermediate layer 13 can be from 1 to 20 nm thick. The thickness in this range has the effect to reduce media noise. The thickness in the range from 1 to 10 nm is more effective in reducing media noise in all the materials mentioned above, with the range from 5 to 10 nm being most preferable.

The recording layer 14 of the invention can be a magnetic layer made of a crystalline alloy of CoCr system. Preferable material for the crystalline alloy film of CoCr system in a perpendicular magnetic recording medium of the present invention includes CoCr, CoCrTa, CoCrPt, and CoCrPtX, wherein X is B, Ta, Zr, or Nb. The thickness of the crystalline alloy film of CoCr system of the recording layer 14 is preferably in the range from 5 nm to 50 nm. The grain size of the recording layer 14 is preferably from 5 to 7 nm and the standard deviation, which is a square root of the variance, of the grain size is preferably from 1.5 to 2.5 nm.

The protective layer 15 can be laminated by using a conventional material, for example, a material composed mainly of carbon. The thickness and other conditions in the protective layer 15 can be adjusted in the same conditions as in a conventional magnetic recording medium. For example, the thickness can be adjusted in the range from 2 to 10 nm.

The liquid lubricant layer 16 can also be formed using a conventional material, such as a perfluoropolyether lubricant. The thickness and other conditions in the liquid lubricant layer 16 also can be adjusted in the same conditions as in a conventional magnetic recording medium. For example, the thickness can be preferably adjusted in the range from 1 to 2 nm.

The second mode of the first aspect of the present invention is a perpendicular magnetic recording medium comprising a substrate, and layers sequentially laminated on the substrate, the layers including an underlayer, an intermediate layer, a recording layer, a protective layer, and a liquid lubricant layer, wherein the intermediate layer is a lamination of an amorphous layer with amorphous structure and a crystalline layer with crystalline structure. The coercive force Hc and the squareness ratio S of the recording layer are improved, as well as reduction of the media noise, by the lamination of the amorphous layer and the crystalline layer of the intermediate layer of the second mode of the first aspect of the present invention.

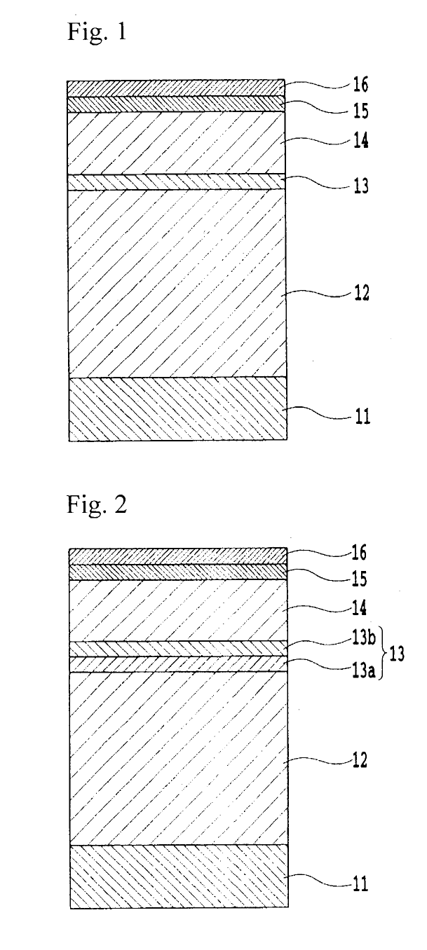

The second mode of the first aspect of the present invention will be described referring to FIG. 2. FIG. 2, however, is a mere exemplary embodiment. Accordingly, the second mode of the first aspect of the invention is not to be limited to this embodiment.

A perpendicular magnetic recording medium of the second mode has an underlayer 12, an intermediate layer 13 consisting of an amorphous layer 13a and a crystalline layer 13b, a recording layer 14, a protective layer 15, and a liquid lubricant layer 16 sequentially laminated on a substrate 11. The substrate 11 can be made of the material that has been described for the first mode of the first aspect of the invention. The material for the underlayer 12 can be selected from the materials suitable for a soft magnetic underlayer for perpendicular magnetic recording, and including the materials described for the first mode. In this second mode, in particular, a CoZr alloy is preferable. More preferable are a CoZrTa alloy and a CoZrNb alloy. The underlayer in the second mode has preferably an amorphous structure. The intermediate layer in the second mode consists of an amorphous layer 13a and a crystalline layer 13b. The materials and other conditions for the recording layer 14, the protective layer 15, and the liquid lubricant layer 16 are similar to those described for the first mode.

As shown in FIG. 2, the amorphous layer 13a is disposed preferably on the underlayer 12 and the crystalline layer 13b is beneath the recording layer 14. That is, the amorphous layer 13a is first deposited and then the crystalline layer 13b is deposited on the amorphous layer 13a. Material for the amorphous layer 13a is preferably a titanium alloy, more preferably an alloy of Ti and Cr, and most preferably an alloy having a composition Ti_{100-c}Cr_{c}, wherein c is in the range from 10 to 25 at %. Material for the crystalline layer 13b in the second mode is preferably a CoCrPt alloy, more preferably a CoCrPtB alloy. One or more additive elements including Ta, Nb, Cu, Ru, Ti, Pd, and Ni may be contained in the crystalline layer 13b. The crystalline layer has preferably a hexagonal closest packed structure. Each thickness of the amorphous layer 13a and the crystalline layer 13b that consist the intermediate layer 13 can be from 1 to 20 nm. The total thickness of whole intermediate layer can be the thickness described for the first mode, namely from 1 to 20 nm.

The second aspect of the first mode of the present invention relates to a method for manufacturing the perpendicular magnetic recording medium. The method of the first mode of the second aspect of the invention comprises the steps of laminating the under-layer 12, laminating the intermediate layer 13, laminating the recording layer 14, laminating the protective layer 15, and laminating the liquid lubricant layer 16 sequentially on the substrate 11. The intermediate layer 13 in the first mode of the invention is made to have an amorphous structure. By forming the recording layer 14 on the intermediate layer 13 that is in an amorphous state, the average grain size of the magnetic recording material is minimized and the variance of the grain size is made small, which means uniform distribution of the grain size.

The first step laminates the under-layer 12 on the substrate 11. The substrate 11 used in this step may be selected from a NiP-plated aluminum alloy, strengthened glass, and crystallized glass, which are used in a conventional magnetic recording medium. Because several layers are laminated on the substrate 11, the substrate should be flat and clean. On this substrate 11, the under-layer 12 is laminated by means of sputtering or plating. The under-layer 12 can be laminated using an amorphous Co alloy, NiFe alloy, a sendust alloy (i.e., an FeSiAl alloy), or an FeTaC alloy. The NiFe alloy is preferable in the present invention. An amorphous cobalt alloy, for example CoNbZr or CoTaZr, also can be used. The thickness of the under-layer 12 is preferably in the range from 5 nm to 200 nm, the optimum value depending on the structure and characteristics of a magnetic head used for recording.

The second step laminates the intermediate layer 13. The intermediate layer 13 may be formed by means of sputtering. The intermediate layer 13 is used for performing the function of magnetically isolating the recording layer 14 from the under-layer 12, and controlling characteristics of the crystalline alloy film of CoCr system of the recording layer 14. Specifically, the intermediate layer 13 in the first mode of the present invention is used for minimizing the grain size and reducing the variance of the grain size in the crystalline film of the recording layer 14. This requires the intermediate layer 13 to have an amorphous structure.

To make the intermediate layer 13 amorphous, the layer 13 is laminated by means of sputtering at a temperature between the room temperature and 250° C., more preferably, between the room temperature and 150° C. under a pressure between 0.1 and 100 mTorr, more preferably between 1 and 20 mTorr. Preferable material for the intermediate layer 13 includes metals of Ti and Zr, and an alloy containing Ti or Zr, as described previously.

The third step laminates the recording layer 14. This layer is formed by means of sputtering using a crystalline alloy of CoCr system as a target. The crystalline alloy of CoCr system includes, for example, CoCr, CoCrTa, CoCrPt, and CoCrPtX, wherein X is B, Ta, Zr, or Nb. The sputtering method in the present invention can use a target that allows forming a crystalline film with a desired composition. The thickness of the crystalline alloy film of CoCr system is preferably in the range from 5 nm to 50 nm. The sputtering is conducted using, for example, argon gas, which is commonly used in sputtering, and sputtering conditions may be adjusted by controlling argon gas flow rate or controlling opening of the valve connecting to a vacuum pump. The argon gas pressure may be controlled in the range from 0.1 mTorr to 100 mTorr, preferably from 1 to 20 mTorr.

By making the intermediate layer 13 to have an amorphous structure in the manufacturing process of a perpendicular magnetic recording medium in the first mode of the present invention, the grain size of the recording layer 14 is minimized and the variance of the grain size is decreased in the process of laminating the recording layer 14. This leads to reduction in media noise.

The next step laminates the protective layer 15. Methods for laminating the protective layer 15 include sputtering method, CVD method, and cathodic arc carbon method. The protective layer 15 is laminated on the recording layer 14 by means of one of these methods. The protective layer 15 can be formed using a conventional material. A material mainly composed of carbon, for example, can be used for forming the layer 15. The thickness and other conditions in the protective layer 15 can be adjusted in the same conditions as in a conventional magnetic recording medium. For example, the thickness can be adjusted in the range from 2 to 10 nm.

When each step described above in the invention is conducted by sputtering, the deposition may be performed under gas pressure of 0.1 mTorr to 100 mTorr, as mentioned above. The more preferable gas pressure is in the range from 1 to 20 mTorr. The sputtering is conducted using argon gas, which is commonly used in sputtering, and the argon gas pressure is adjusted by controlling argon gas flow rate or controlling opening of the valve connecting to a vacuum pump. Other conditions may be appropriately selected corresponding to the deposition condition of each layer. The temperature, for example, can be adjusted between the room temperature and 500° C.

The sputtering method may be mainly used in the manufacturing method of the invention. The sputtering method is advantageous because it allows continuous processing in a series of steps in one vacuum chamber. However, other methods also can be applied in the first mode of the present invention, as long as the intermediate layer 13 is made amorphous, and the fine grain size and the small variance of the grain size of the recording layer 14 are achieved.

The magnetic recording medium with thus laminated layers is taken out from the vacuum chamber, and finally, a liquid lubricant layer 16 is laminated. The liquid lubricant layer 16 can be formed using a conventional material, such as a perfluoropolyether lubricant. The liquid lubricant layer 16 can be laminated by coating the magnetic recording medium processed in the above-described steps with a solution of the lubricant dissolved in a proper solvent by means of a dip-coating method, a spray method, or a spin-coating method. The thickness and other conditions in the liquid lubricant layer 16 can be adjusted in the same conditions as in a conventional magnetic recording medium. For example, the thickness can be adjusted in the range from 1 to 2 nm.

The second mode of the second aspect of the present invention will now be described. The method of the second mode comprises the steps of laminating the underlayer 12, laminating the amorphous layer 13a of the intermediate layer 13, laminating the crystalline layer 13b of the intermediate layer, laminating the recording layer 14, laminating the protective layer 15, and laminating the liquid lubricant layer 16 sequentially on the substrate 11. The intermediate layer 13 in the second mode consists of the amorphous layer 13a and the crystalline layer 13b. By providing the intermediate layer consisting of the amorphous layer and the crystalline layer, the improvements of the coercive force Hc and the squareness ratio S of the recording layer are achieved that are compatible with the reduction of media noise.

The steps in the second mode other than the step of forming the intermediate layer 13 are the same as those described for the first mode. Namely, the steps of laminating the underlayer 12 on the substrate 11, laminating the recording layer 14, laminating the protective layer 15, and laminating the liquid lubricant layer 16 are all same as those for the first mode. Accordingly, the description for the steps except for the step of forming the intermediate layer 13 is also applied to the description for the second mode.

The material for the underlayer 12 in the second mode can be selected from the materials suitable for a soft magnetic underlayer for perpendicular magnetic recording, including those described for the first mode. In this second mode, in particular, CoZr alloys are preferable. More preferable are a CoZrTa alloy and a CoZrNb alloy. The underlayer in the second mode has preferably an amorphous structure.

The steps of laminating the amorphous layer 13a and the crystalline layer 13b that consist the intermediate layer 13 will now be described below. The second step in the second mode is the step of forming the intermediate layer consisting of the amorphous layer 13a and the crystalline layer 13b. The two layers can be deposited by means of a sputtering method. The intermediate layer 13 is provided for controlling properties of the CoCr alloy crystalline film of the recording layer 14, in addition to the function to magnetically isolate the recording layer 14 from the underlayer 12. The intermediate layer 13 consisting of the amorphous layer 13a and the crystalline layer 13b in the second mode leads to improvements in Hc and S of the recording layer that are compatible with the reduction of media noise. The amorphous layer 13a can be made amorphous structure by depositing the amorphous layer 13a by means of a sputtering method at a temperature between the room temperature and 250° C., preferably between the room temperature and 150° C., under a pressure of between 0.1 and 100 mTorr, preferably between 1 and 20 mTorr. A titanium alloy is favorably used for the material of the amorphous layer 13a. A TiCr alloy, in particular, is preferable. A preferable TiCr alloy has a composition of Ti_{100-c}Cr_{c} in which c is from 10 to 25 at %. The Thickness of the amorphous layer 13a is preferably from 1 to 20 nm thick. The thickness in that range leads to effectively reduce media noise.

Next, the process of depositing the crystalline layer 13b will be described. The crystalline layer 13b can be deposited by means of a sputtering method at a temperature between the room temperature and 500° C. under a pressure between 1 mTorr and 50 mTorr. In this second mode, the crystalline layer 13b is deposited by sputtering preferably at a temperature of from 150 to 250° C. under a pressure of from 10 to 25 mTorr.

The material for the crystalline layer 13b is preferably a CoCrPt alloy, and more preferably an alloy of CoCrPtB. In the second mode, one or more elements selected from Ta, Nb, Cu, Ru, Ti, Pd, or Ni, for example, may be contained in the crystalline layer 13b. The crystalline layer has preferably a hexagonal closest packed structure. For obtaining a hexagonal closest packed structure in the crystalline layer 13b, the deposition process by sputtering is conducted at a temperature between the room temperature and 500° C., preferably in the range from 150 to 250° C., under a pressure between 1 mTorr and 50 mTorr, preferably in the range from 10 mTorr to 25 mTorr.

Each thickness of the amorphous layer 13a and the crystalline layer 13b that consist the intermediate layer 13 is preferably in the range from 1 to 20 nm. The total thickness of the intermediate layer is preferably the thickness described for the first mode, which is from 1 to 20 nm.

The examples of the present invention will be further described below referring to Examples 1-1 through 1-4 and 2-1 through 2-3. These Examples are only for explaining the invention, not for restricting the scope of the invention. In the description below, a numeral following a symbol of an element represents the content in atomic percent of the element. For example, the notation ‘Ti90Cr10’ represents containment of 90 at % of titanium and 10 at % of chromium.

### FIRST GROUP OF EXAMPLES

Examples 1-1 through 1-4 are the examples of perpendicular magnetic recording media having an intermediate layer with amorphous structure.

The substrate used was a commercially available glass substrate having an outer diameter of 95 mm and a thickness of 1.0 mm. The substrate was cleaned and introduced into a vacuum chamber of a sputtering apparatus. Laminated to the substrate were, an under-layer of a NiFe alloy with a thickness of 20 nm, and an intermediate layer with a thickness of 5 nm, as described in Examples and Comparative Examples below, and a recording layer of Co66-Cr20-Pt12-B2 with a thickness of 28 nm. The temperature and pressure in the sputtering process were 250° C. and 5 mTorr. After laminating a carbon protective layer having a thickness of 7 nm by sputtering, the resulting substrate was taken out from the vacuum chamber. Finally, a liquid lubricant layer of perfluoropolyether with a thickness of 2 nm was formed by dip-coating. Thus, a perpendicular magnetic recording medium was manufactured.

### Example 1-1

A perpendicular magnetic recording medium was prepared according to the above-described manufacturing method with an intermediate layer formed by using Zr50-Ru50.

### Example 1-2

A perpendicular magnetic recording medium was prepared according to the above-described manufacturing method with an intermediate layer formed by using Zr.

### Example 1-3

A perpendicular magnetic recording medium was prepared according to the above-described manufacturing method with an intermediate layer formed by using Ti75-Cr25.

### Example 1-4

A perpendicular magnetic recording medium was prepared according to the above-described manufacturing method with an intermediate layer formed by using Ti.

### Comparative Example 1-1

A perpendicular magnetic recording medium was prepared according to the above-described manufacturing method with an intermediate layer formed by using Ru.

### Comparative Example 1-2

A perpendicular magnetic recording medium was prepared according to the above-described manufacturing method with an intermediate layer formed by using Co55-Cr45.

### Comparative Example 1-3

A perpendicular magnetic recording medium was prepared according to the above-described manufacturing method with an intermediate layer formed by using Co50-Cr25-Ru25.

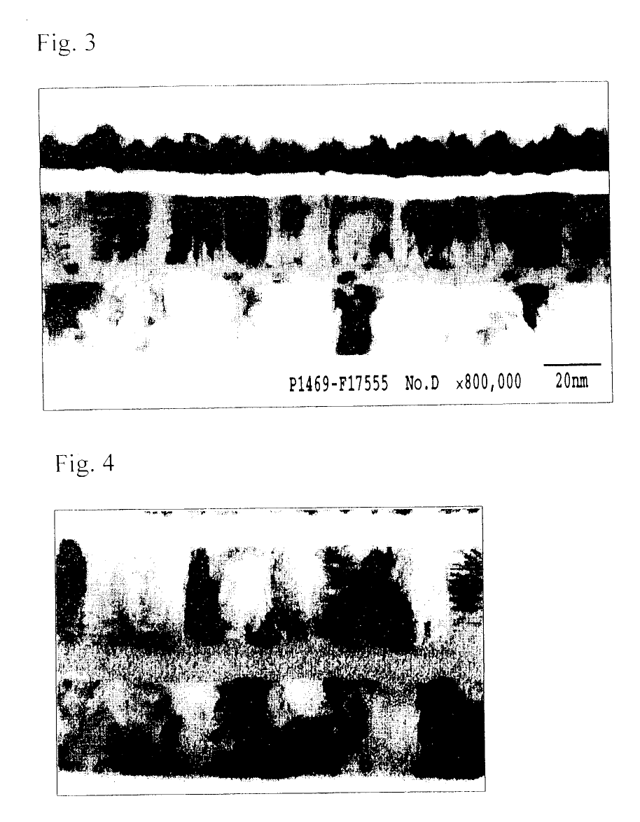

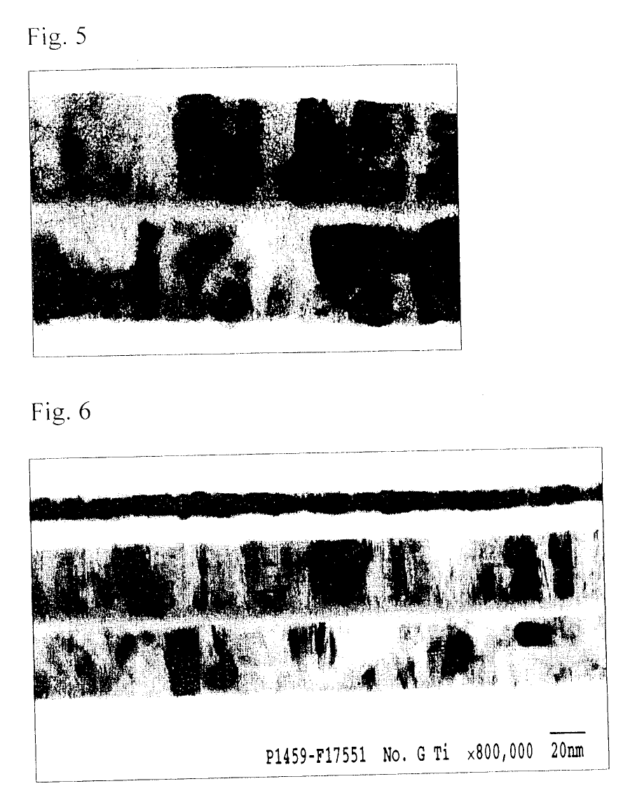

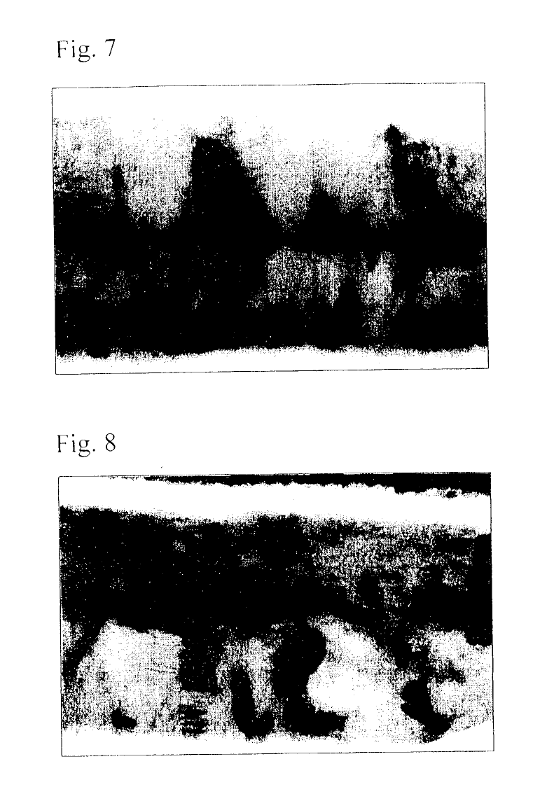

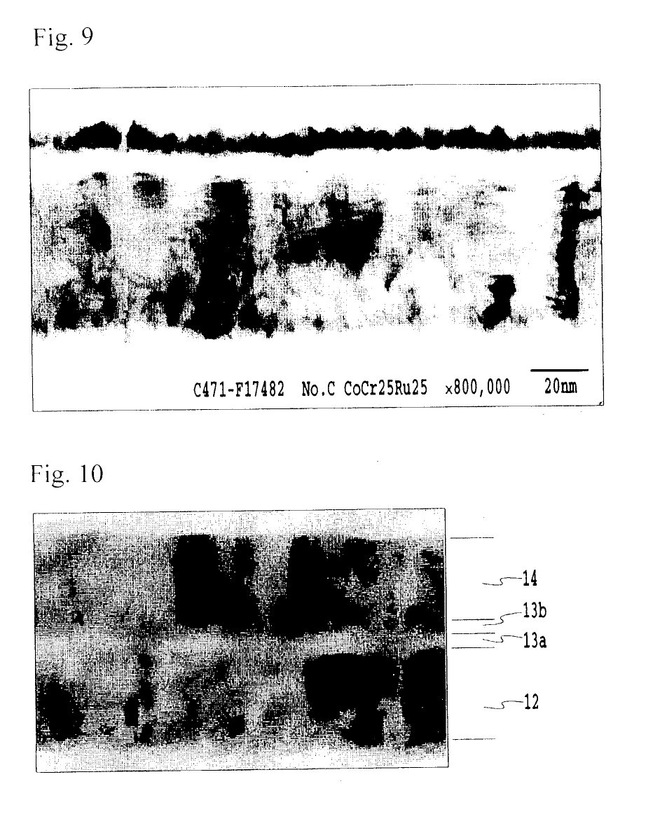

FIGS. 3 through 9 illustrate photographs of the cross-sections of the obtained perpendicular magnetic recording media taken by a transmission electron microscope (TEM). The structures of the intermediate layers were observed. The grain size distribution was measured by processing a dark field picture on the TEM. The film thickness was measured using a contact profile meter. The electromagnetic conversion characteristic was measured using a commercially available spinning stand equipped with a head for a hard disk and a circuit for electromagnetic conversion measurement.

All of Examples 1-1 through 1-4 showed an amorphous structure, as illustrated in FIGS. 3 through 6. This is known from the fact that a layer of homogeneous structure without a crystalline structure was observed at the intermediate layer portion of the picture. All of Comparative Examples 1-1 through 1-3, in contrast, showed a crystalline structure, as illustrated in FIGS. 7 through 9. The differences in crystal structure cannot be found between the under-layer and the recording layer, except the contrast in brightness corresponding to the atomic number.

Table 1 summarizes the measured results of the grain sizes of the recording layer obtained by the TEM for the recording media having the intermediate layer indicated in the Examples and Comparative Examples. It is apparent that the average grain size and the standard deviation of the grain size have been significantly reduced in the Examples 1-1 through 1-4 as compared with the Comparative Examples 1-1 through 1-3. The deviation in Table 1 is defined by the following equation:

Deviation=standard deviation (nm)/average grain size (nm)×100 (%)

TABLE 1
Measured grain size of the recording layer

| | | | | | Comp | Comp Ex | Comp Ex |
|---|---|---|---|---|---|---|---|
| | Example 1 | Example 2 | Example 3 | Example 4 | Ex 1 | 2 | 3 |
| material | Zr50-Ru50 | Zr | Ti75-Cr25 | Ti | Ru | Co55- | Co50- |
| | | | | | | Cr45 | Cr25- |
| | | | | | | | Ru25 |
| average | 6.3 | 5.8 | 5.9 | 6.7 | 11.5 | 11.2 | 8.3 |
| grain size | | | | | | | |
| (nm) | | | | | | | |
| standard | 1.83 | 1.58 | 1.56 | 2.28 3.94 | 3.60 | 2.52 | |
| deviation | | | | | | | |
| (nm) | | | | | | | |
| deviation | 29.2 | 27.1 | 26.6 | 34.1 | 34.3 | 32.1 | 30.3 |
| (%) | | | | | | | |

The media signal-to-noise ratio for each sample of the Examples 1-1 through 1-4 and the Comparative Examples 1-1 through 1-3 was measured using a commercially available GMR head for areal recording density of 15 Gbits/in² at the rotating speed of 4,500 rpm, at the radial position of 30 mm, and in the skew angle of zero degree. The head flying height was about 25 nm. A comparison was made at the linear recording density of 160 kfci. The output used for the signal-to-noise ratio calculation was an average output obtained from one whole track. The noise used for the calculation was a square root of the integration over the frequency band of 1 to 200 MHz of the value that was obtained by subtracting the output signal and the circuit noise at each frequency from the output spectrum value at the normal linear recording density. The results are shown in Table 2. This table demonstrates the improvement by 3 to 4 dB in the Examples 1-1 through 1-4 compared with Comparative Examples 1-1 through 1-3. There is no significant difference in the signal-to-noise ratio among the Examples 1-1 through 1-4 and also among the Comparative Examples 1-1 through 1-3. Consequently, the improvement by 3 to 4 dB can be attributed to the effect of reducing the average grain size and the variance of the grain size by employing the amorphous intermediate layer, as explained earlier.

TABLE 2
Signal-to-noise ratio, an electromagnetic conversion characteristic,
measured at a linear recording density of 160 kfci.

| | | | | | Comp | Comp | Comp Ex |
|---|---|---|---|---|---|---|---|
| | Example 1 | Example 2 | Example 3 | Example 4 | Ex 1 | Ex 2 | 3 |
| material | Zr50-Ru50 | Zr | Ti75-Cr25 | Ti | Ru | Co55- | Co50- |
| | | | | | | Cr45 | Cr25- |
| | | | | | | | Ru25 |
| S/N (dB) | 16.0 | 16.1 | 16.7 | 17.4 | 13.4 | 13.1 | 13.2 |

### SECOND GROUP OF EXAMPLES

Examples 2-1 through 2-3 are examples of perpendicular magnetic recording media having an intermediate layer consisting of an amorphous layer and a crystalline layer.

The substrate used was a commercially available glass substrate having an outer diameter of 95 mm and a thickness of 1.0 mm. The substrate was cleaned and introduced into a vacuum chamber of a sputtering apparatus. Laminated to the substrate were, an under-layer of Co92-Zr5-Ta3 with amorphous structure and a thickness of 200 nm, and an intermediate layer with a thickness of 5 nm as described in Examples and Comparative Examples below, and a recording layer of Co62-Cr20-Pt14-B4 with a thickness of 20 nm. The temperature and pressure in the sputtering process were 250° C. and 5 mTorr. After laminating a carbon protective layer having a thickness of 7 nm by sputtering, the resulting substrate was taken out from the vacuum chamber. Finally, a liquid lubricant layer of perfluoropolyether with a thickness of 1.5 nm was formed by dip-coating. Thus, a perpendicular magnetic recording medium was manufactured.

### Example 2-1

A perpendicular magnetic recording medium was prepared according to the above-described manufacturing method with an intermediate layer formed by using Ti90-Cr10 for the amorphous layer 13a and Co59-Cr25-Pt14-B2 for the crystalline layer 13b. The measurements by the transmission electron microscope (TEM) in the evaluation below were conducted using the magnetic recording media having an underlayer of a nonmagnetic NiFeCr alloy 20 nm thick.

### Example 2-2

A perpendicular magnetic recording medium was prepared according to the above-described manufacturing method with an intermediate layer formed by using Ti75-Cr25 for the amorphous layer 13a and Co59-Cr25-Pt14-B2 for the crystalline layer 13b.

Example 2-3: A perpendicular magnetic recording medium was prepared according to the above-described manufacturing method with an underlayer formed by using Ni80-Fe20, and with an intermediate layer formed by using Ti90-Cr10 for the amorphous layer 13a and Co59-Cr25-Pt14-B2 for the crystalline layer 13b.

### Comparative Example 2-1

A perpendicular magnetic recording medium was prepared according to the above-described manufacturing method with an intermediate layer formed by using Ti. The measurements by the transmission electron microscope (TEM) in the evaluation below were conducted using the magnetic recording media having an underlayer of a nonmagnetic NiFeCr alloy 20 nm thick.

### Comparative Example 2-2

A perpendicular magnetic recording medium was prepared according to the above-described manufacturing method with an intermediate layer formed by using Ru.

### Comparative Example 2-3

A perpendicular magnetic recording medium was prepared according to the above-described manufacturing method with an underlayer formed by using Ni80-Fe20 with an intermediate layer formed by using Ti90-Cr10.

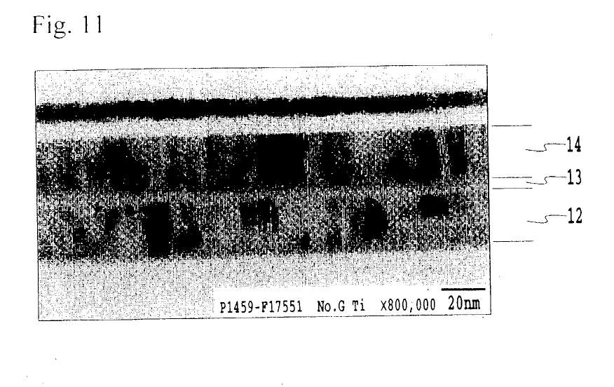

FIGS. 10 and 11 illustrate photographs of the cross-sections of the obtained perpendicular magnetic recording media of Example 2-1 and Comparative Example 2-1 taken by a transmission electron microscope (TEM). The structures of the intermediate layers were observed. The grain size distribution was measured by processing a dark field picture on the TEM. The film thickness was measured using a contact profile meter. The electromagnetic conversion characteristic was measured using a commercially available spinning stand equipped with a head for a hard disk and a circuit for electromagnetic conversion measurement. Homogeneous layer structures without crystalline structure were observed at the region of the amorphous layer 13a in FIG. 10 and the region of the intermediate layer 13 in FIG. 11. It is well known that such images are commonly observed in amorphous structure.

The picture of FIG. 10 for Example 2-1 is observed divided into an amorphous layer 13a and the other regions, while the boundary between the crystalline layer 13b and the recording layer 14 is unclear. When a substance of different composition epitaxially grows on a base substance, clear phase difference is generally not observed in a TEM picture, but only contrast of brightness is observed depending on the atomic number of the substance in each layer. The picture of FIG. 10 for Example 2-1 shows the difference in the layers other than the crystalline phase 13b and the recording layer 14. The contrast of brightness cannot be seen between the crystalline layer 13b and the recording layer 14 in FIG. 10, because the composition of the platinum, which has the largest atomic number in the composition of these two layers, is equally 14 at % in the crystalline layer 13b and in the recording layer 14. Accordingly, it can be known that the recording layer 14 is epitaxially well grown on the crystalline layer 13b in the Example 2-1.

The magnetic properties, specifically coercive force Hc and squareness ratio S, of the magnetic recording media prepared in Examples 2-1 through 2-3 and Comparative Example 2-1 through 2-3 are given in Table 3. For measuring these magnetic properties, the magnetic Kerr effect measuring equipment manufactured by NEOARK Corporation, Tokyo, Japan, was used to measure the polar Kerr effect in the conditions of the maximum applied magnetic field of 15 kOe and the field sweep rate of 2 kOe/sec. The magnetic recording media according to the second mode of the invention have achieved significant improvement in the coercive force Hc as compared with the medium having an intermediate layer of Ti90-Cr10, in particular.

Table 3 also shows the S/N ratio of the perpendicular magnetic recording media prepared in Examples 2-1 through 2-3 and Comparative Examples 2-1 through 2-3. The S/N ratio was measured using a single magnetic pole type perpendicular magnetic recording head for areal recording density of 45 Gbits/in² at the rotating speed of 5,400 rpm, at the radial position of 30 mm, and in the skew angle of zero degree. The head flying height was about 13 nm. A comparison was made in the linear recording density of 200 kfci. The output used for the S/N ratio calculation was an average output obtained from one whole track. The noise used for the calculation was a square root of the integration over the frequency band of 1 to 200 MHz of the value that was obtained by subtracting the signal component and the circuit noise at each frequency from the output spectrum value at the normal linear recording density.

TABLE 3
Measured magnetic properties, S/N ratio, and grain size

| | Example | Example | Example | Comp | Comp | Comp |
|---|---|---|---|---|---|---|
| | 2-1 | 2-2 | 2-3 | Ex 2-1 | Ex 2-2 | Ex 2-3 |
| crystalline layer | Co59-Cr25- | Co59-Cr25- | Co59-Cr25- | Ti | Ru | Ti90- |
| material | Pt14-B2 | Pt14-B2 | Pt14-B2 | | | Cr10 |
| amorphous layer | Ti90-Cr10 | Ti75-Cr25 | Ti90-Cr10 | | | |
| material | | | | | | |
| coercive force | 2,920 | 2,840 | 2,530 | 2,090 | 3,380 | 2,120 |
| Hc (Oe) | | | | | | |
| squareness ratio | 0.66 | 0.65 | 0.60 | 0.50 | 0.69 | 0.65 |
| S | | | | | | |
| S/N (dB) | 21.9 | 21.2 | 20.2 | 19.2 | 17.5 | 19.7 |
| at 200 kfci | | | | | | |
| average grain | 5.5 | 6.1 | 6.2 | 6.7 | 11.5 | no data |
| size (nm) | | | | | | |
| Standard | 2.12 | 2.24 | 2.68 | 2.28 | 3.94 | no data |
| deviation (nm) | | | | | | |
| deviation (%) | 38.3 | 36.6 | 43.0 | 34.1 | 34.3 | no data |

As shown in Table 3, the S/N ratio has been improved in Examples 2-1 through 2-3 by 1.0 to 2.7 dB as compared with Comparative Example 2-1.

Comparative Example 2-2 is an example using ruthenium, which is a crystalline substance, in place of titanium in Comparative Example 2-1, exhibited the improved magnetic properties Hc and S as compared with Comparative Example 2-1, though S/N ratio was deteriorated.

Example 2-3 used the NiFe alloy for the underlayer 12 in place of the CoZrTa alloy in Example 2-1. The NiFe alloy is known as a crystalline material having fcc structure. The Example 2-3 is within the scope of the present invention, and the magnetic properties and the S/N ratio are improved in comparison with Comparative Example 2-1 as shown in Table 3. Comparing Example 2-1 with Example 2-3, Example 2-1 is superior in both magnetic properties and S/N ratio, which indicates the underlayer with amorphous structure more favorable.

The data for the average grain size, the standard deviation thereof, and the deviation defined earlier are also given for Examples 2-1 through 2-3 and Comparative Examples 2-1 and 2-2 in Table 3. Those data demonstrate that the grain sizes in the magnetic recording media in the second group of Examples are reduced as compared with in the conventional magnetic recording medium.

As described above, a TiCr alloy is favorable for the amorphous layer 13a, and a CoCrPt alloy, particularly CoCrPtB alloy, is favorable for the crystalline layer 13b in the present invention. A material with amorphous structure, in particular a CoZr alloy, is favorable for the material of the underlayer 12.

Media noise has been reduced in the first mode of the present invention by forming an intermediate layer having an amorphous structure over a substrate by means of sputtering, for example. This provides a magnetic recording medium with a high recording density. The intermediate layer in the first mode of the present invention preferably uses titanium, zirconium, or an alloy containing titanium or zirconium.

Media noise has also been reduced in the second mode of the present invention by forming an intermediate layer consisting of an amorphous layer and a crystalline layer by means of sputtering, for example. The crystalline layer has preferably hexagonal closed packed structure. These structures of the invention provide a magnetic recording medium with a high recording density. The amorphous layer 13a is preferably made of a TiCr alloy, and the crystalline layer 13b is preferably made of a CoCrPt alloy. The underlayer 12 has preferably an amorphous structure.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

I claim:

1. A perpendicular magnetic recording medium comprising:
a substrate; and
an under-layer, an intermediate layer having an amorphous structure, a recording layer, a protective layer, and a liquid lubricant layer sequentially laminated on the substrate,
wherein the recording layer formed on the intermediate layer has a fine grain size and a uniform grain size distribution by providing the intermediate layer with the amorphous structure.

2. A perpendicular magnetic recording medium according to claim 1, wherein the intermediate layer has a composition of Ti₁₀₀₋ₐXₐ, where X is chromium (Cr) or ruthenium (Ru) and a is 0≦a<100 in atomic percent.

3. A perpendicular magnetic recording medium according to claim 2, wherein a is 0<a≦50.

4. A perpendicular magnetic recording medium according to claim 2, wherein X is Cr.

5. A perpendicular magnetic recording medium according to claim 1, wherein the intermediate layer has a composition of Zr_{100-b}Y_{b}, where Y is Cr or Ru and b is 0≦b<100 in atomic percent.

6. A perpendicular magnetic recording medium according to claim 5, wherein b is 0<b≦75.

7. A perpendicular magnetic recording medium according to claim 5, wherein Y is Ru.

8. A perpendicular magnetic recording medium according to claim 1, wherein the thickness of the intermediate layer is in the range from 1 nm to 20 nm.

9. A perpendicular magnetic recording medium comprising:
a substrate; and
an under-layer, an intermediate layer, a recording layer, a protective layer, and liquid lubricant layer sequentially laminated on the substrate,
wherein the intermediate layer is a lamination of an amorphous layer with amorphous structure and a crystalline layer with crystalline structure deposited on the amorphous layer.

10. A perpendicular magnetic recording medium according to claim 9, wherein a crystal structure of the crystalline layer of the intermediate layer is a hexagonal closest packed structure.

11. A perpendicular magnetic recording medium according to claim 9, wherein the crystalline layer of the intermediate layer is substantially composed of Co, Cr, and Pt.

12. A perpendicular magnetic recording medium according to claim 9, wherein the crystalline layer of the intermediate layer is substantially composed of Co, Cr, Pt, and B.

13. A perpendicular magnetic recording medium according to claim 9, wherein the amorphous layer of the intermediate layer is composed of a titanium alloy.

14. A perpendicular magnetic recording medium according to claim 13, wherein the titanium alloy is a TiCr alloy.

15. A perpendicular magnetic recording medium according to claim 9, wherein the underlayer has amorphous structure.

16. A perpendicular magnetic recording medium according to claim 15, wherein the underlayer is composed of a CoZr alloy.

17. A perpendicular magnetic recording medium according to claim 16, wherein the underlayer is composed of an alloy of Co, Zr, and one or more additive elements selected from the group consisting of Ta, Nb, B, Cu, Ni, and Cr.

18. A method of manufacturing a perpendicular magnetic recording medium comprising the steps of sequentially laminating an under-layer, an intermediate layer, a recording layer, a protective layer, and a liquid lubricant layer on a substrate, wherein said intermediate layer has an amorphous structure, and the recording layer formed on the intermediate layer has a fine grain size and a uniform grain size distribution by providing the intermediate layer with the amorphous structure.

19. A method of manufacturing a perpendicular magnetic recording medium according to claim 18, wherein the intermediate layer has a composition of Ti₁₀₀₋ₐXₐ, where X is Cr or Ru and a is 0≦a<100 in atomic percent.

20. A method of manufacturing a perpendicular magnetic recording medium according to claim 19, wherein a is 0<a≦50.

21. A method of manufacturing a perpendicular magnetic recording medium according to claim 19, wherein X is Cr.

22. A method of manufacturing a perpendicular magnetic recording medium according to claim 18, wherein the intermediate layer has a composition of Zr_{100-b}Y_{b}, where Y is Cr or Ru and b is 0≦b<100 in atomic percent.

23. A method of manufacturing a perpendicular magnetic recording medium according to claim 22, wherein b is 0<b≦75.

24. A method of manufacturing a perpendicular magnetic recording medium according to claim 22, wherein Y is Ru.

25. A method of manufacturing a perpendicular magnetic recording medium according to claim 18, wherein the thickness of the intermediate layer is in the range from 1 nm to 20 nm.

26. A method of manufacturing a perpendicular magnetic recording medium comprising the steps of sequentially laminating an under-layer, an intermediate layer, a recording layer, a protective layer, and a liquid lubricant layer on a substrate, wherein the step of laminating the intermediate layer consists of first process of depositing an amorphous layer with an amorphous structure and second process of depositing an crystalline layer with a crystalline structure.

27. A method of manufacturing a perpendicular magnetic recording medium according to claim 26, wherein a crystal structure of the crystalline layer of the intermediate layer is a hexagonal closest packed structure.

28. A method of manufacturing a perpendicular magnetic recording medium according to claim 26, wherein the crystalline layer of the intermediate layer is substantially composed of Co, Cr, and Pt.

29. A method of manufacturing a perpendicular magnetic recording medium according to claim 26, wherein the crystalline layer of the intermediate layer is substantially composed of Co, Cr, Pt, and B.

30. A method of manufacturing a perpendicular magnetic recording medium according to claim 26, wherein the amorphous layer of the intermediate layer is composed of a titanium alloy.

31. A method of manufacturing a perpendicular magnetic recording medium according to claim 30, wherein the titanium alloy is a TiCr alloy.
